(19) United States
(12) Patent Application Publication
(10) Pub. No.: US 2009/0303160 A1
(43) Pub. Date: Dec. 10, 2009

(54) APPARATUS AND METHOD FOR DELETING DUPLICATE IMAGE FILES

(75) Inventors: CHUN-KEONG CHEW, Tu-Cheng (TW); HUAN-HIM KHOR, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/237,669

(22) Filed: Sep. 25, 2008

(30) Foreign Application Priority Data
Jun. 10, 2008 (CN) 200810302078.3

(51) Int. Cl. G09G 3/20

(52) U.S. Cl. 345/55

(57) ABSTRACT

A method for deleting duplicate image files in a digital photo frame (DPF) includes selecting an image file for comparing to other image files in the DPF, determining if names of other image files and a name of the selected image file are the same, and determining if sizes of matching image files and a size of the selected image file are the same. If sizes are matching, the selected image file or the matching image files are automatically deleted. If the matching image files do not have the same size as the selected image file, a prompt asks if the user would like to delete the different sized matching image files or modify the names of the image files.

### BACKGROUND

1. Technical Field

The present invention relates to an apparatus and a method for deleting duplicate image files in a digital photo frame.

2. Description of Related Art

A typical digital photo frame is capable of storing many different types of files such as image files and audio files. Users may put duplicate image files in different folders. When the users want to delete the duplicate image files, they have to delete them one by one inform the different folders. Thus, file management is inconvenient.

Therefore, there is room for improvement within the art.

### BRIEF DESCRIPTION OF THE DRAWINGS

FIG. 1 is a flow chart of a method for deleting duplicate image files in a digital photo frame; and

FIG. 2 is a view of the digital photo frame using the method for deleting duplicate image files.

### DETAILED DESCRIPTION OF EMBODIMENTS

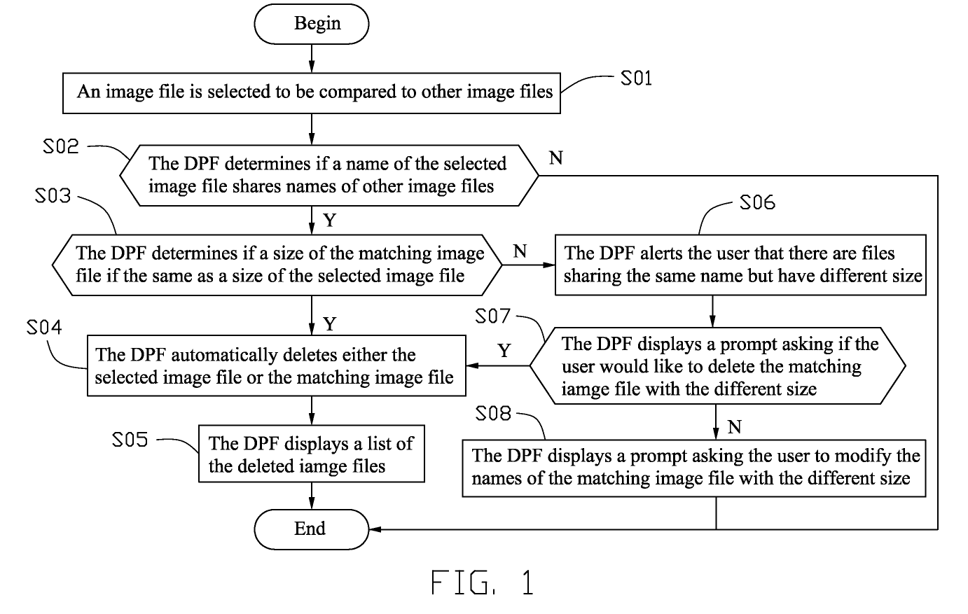

FIG. 1 is a flow chart illustrating a method for deleting duplicate image files in a digital photo frame (DPF) 10. Depending on the embodiment, certain steps described below may be removed, while others may be added, and the sequence of steps may be altered as well.

In a step S01, an image file is selected by the digital photo frame 10 to be compared to other image files in the digital photo frame.

Continuing to a decision step S02, the digital photo frame 10 determines if a name of the selected image file shares names of other image files. If the name of the selected image file matches a name of a matching image file of other image files, the method proceeds to a step S03. If there is no matching name, the process ends.

In the step S03, the digital photo frame 10 determines if a size of the matching image file is the same as a size of the selected image file. If the sizes are the same, the matching image file is a duplicate image file and the method proceeds to a step S04. If the sizes are not the same, the method proceeds to a step S06.

In the step S04, the digital photo frame 10 automatically deletes either the selected image file or the matching image file.

Moving to a step S05, the digital photo frame 10 displays a list of the deleted image files and the process ends.

In the step S06, the digital photo frame 10 alerts the user that there are files sharing the same name but have different sizes.

Continuing to a step S07, the digital photo frame 10 displays a prompt asking if the user would like to delete the matching image file with the different size. If the user selects to delete the matching image file, the method proceeds to S04. If the user selects not to delete the matching image file, then the method proceed to a step S08.

In the step S08, the digital photo frame 10 displays a prompt asking the user to modify the names of the matching image file with the different size.

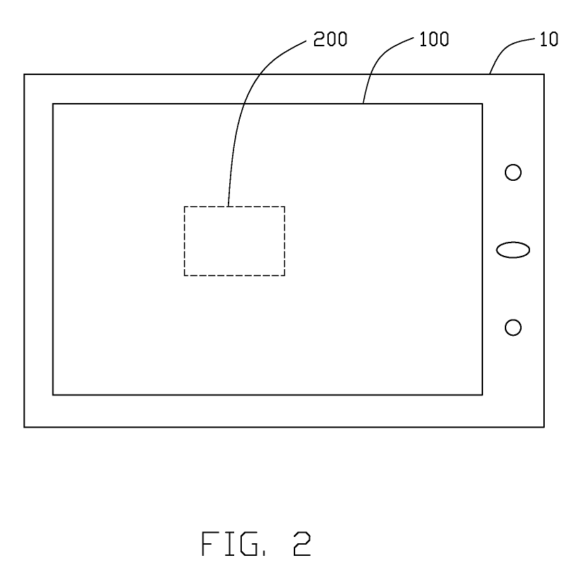

FIG. 2 is the digital photo frame 10 using the method for deleting duplicate image files described above. The digital photo frame 10 includes a display screen 100 and an internal unit 200. The internal unit 200 is configured to find files stored in the digital photo frame 10 and prompt the user to delete or change matching files in accordance with the above-described method.

It is to be understood, however, that even though numerous characteristics and advantages of the present embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A method for deleting duplicate image files in a digital photo frame (DPF), the method comprising:
selecting an image file for comparing to other image files in the DPF;
determining if names of other image files and a name of the selected image file are the same;
determining if sizes of matching image files of the other image files and a size of the selected image file are the same, if names are matching;
deleting automatically the selected image file or the matching image files having the same size as the selected image file, if the sizes are matching;
alerting the user if the matching image files are not the same size as the size of the selected image file; and
displaying a prompt asking if the user would like to delete different sized matching image files; deleting the different sized matching image files if the user selects to delete; prompting the user to modify the names of the image files if the user selects not to delete.

2. The method of claim 1, further comprising displaying a list of the deleted image files in the DPF.

3. A digital photo frame comprising:
a display screen for displaying image files stored in the digital photo frame; and an internal unit configured to determine if a name of the selected image file and names of other image files are the same, determine if sizes of matching image files of the other image files and a size of the selected image file are the same, and automatically delete the selected image file or the matching image files having the same size as the selected image file; the internal unit is further configured to alert the user if the matching image files are not the same size as the size of the selected image file, display a prompt asking if the user would like to delete different sized matching image files or modify the names of the image files.
